(19) United States
(12) Patent Application Publication
(10) Pub. No.: US 2026/0322523 A1
(43) Pub. Date: Oct. 15, 2026

(54) ARTIFICIAL INTELLIGENCE-BASED IDENTIFICATION METHOD FOR WIRELESS COMPOSITE JAMMING SIGNAL

(71) Applicant: UNIVERSITY OF ELECTRONIC SCIENCE AND TECHNOLOGY OF CHINA, Chengdu (CN)

(72) Inventors: Min JIANG, Chengdu (CN); Yuqing ZHANG, Chengdu (CN); Ziqiang YE, Chengdu (CN); Yue XIAO, Chengdu (CN)

(73) Assignee: UNIVERSITY OF ELECTRONIC SCIENCE AND TECHNOLOGY OF CHINA, Chengdu (CN)

(21) Appl. No.: 19/234,321

(22) Filed: Jun. 11, 2025

(30) Foreign Application Priority Data
Apr. 10, 2025 (CN) 202510446636.7

(51) Int. Cl. H04K 3/00

(52) U.S. Cl. CPC H04K 3/45

(57) ABSTRACT

An artificial intelligence-based identification method for a wireless composite jamming signal forms a novel neural network structure ACSNet through the integration of an asymmetric convolutional block (ACB), aiming to address composite jamming signal identification in wireless communication systems. The model of the artificial intelligence-based identification method enhances the detection capability of neural networks for subtle signal feature variations based on artificial intelligence, thereby improving the identification accuracy for intricate jamming patterns. The artificial intelligence-based identification method can effectively address the challenge of jamming signal identification under a low jamming-to-noise ratio (JNR). Additionally, ACSNet demonstrates significant resilience to variations in power ratios (PRs) of composite jamming signals, highlighting its adaptability to real-world environments with imbalanced jamming signal power distributions.

### CROSS REFERENCE TO THE RELATED APPLICATIONS

This application is based upon and claims priority to Chinese Patent Application No. 202510446636.7, filed on Apr. 10, 2025, the entire contents of which are incorporated herein by reference.

### TECHNICAL FIELD

The present disclosure belongs to the technical field of wireless communication, and in particular relates to an artificial intelligence-based identification method for a wireless composite jamming signal.

### BACKGROUND

With the widespread application of wireless communication technologies, wireless signals have become increasingly critical in military, communication, navigation, Internet of Things (IoT), etc. However, wireless signals are prone to various jamming during transmission, particularly intentional artificial jamming and composite jamming in complex electromagnetic environments, which severely threatens the stability and security of communication systems. Composite jamming typically refers to the superimposed coexistence of multiple jamming signals (such as single-tone jamming, multi-tone jamming, linear frequency-sweeping jamming, partial-band jamming, and pulse jamming). Due to its complex time-frequency characteristics and difficulties in identification, composite jamming has become a significant research issue in the field of wireless security.

Existing jamming identification methods primarily rely on spectrum analysis, energy detection, correlation measurement, and traditional machine learning techniques. These methods demonstrate acceptable performance in identifying single-type jamming but are prone to confusion and misclassification when confronted with composite jamming signals formed by the superposition of various jamming. Particularly, their identification accuracy significantly declines in low signal-to-noise ratio (SNR) or low jamming-to-noise ratio (JNR) environments, failing to meet the demands of practical complex application scenarios. In recent years, the widespread application of artificial intelligence, especially deep learning in signal processing, has provided novel approaches for identification of complex jamming signals. By constructing neural network models (such as convolutional neural networks (CNNs) and recurrent neural networks (RNNs), etc.), automatic feature extraction and identification of signals in time-domain, frequency-domain, and time-frequency images can be achieved, enhancing the system's intelligence level and jamming detection capabilities. Current time-frequency analysis methods include short-time Fourier transform (STFT), Wigner-Ville distribution (WVD), and Choi-Williams distribution (CWD), etc. However, existing research primarily focuses on single-jamming identification tasks and demonstrates high sensitivity to variations in power combinations among different jamming signals (i.e., power ratios (PRs) in composite jamming). Their generalization capabilities and robustness remain to be further enhanced.

Currently, the main challenge lies in the fact that the existing methods are predominantly designed for single jamming types. Consequently, they often struggle to accurately distinguish different jamming components in composite jamming signals formed by the superimposition of multiple jamming forms, resulting in reduced identification rates. Additionally, in practical wireless communication environments, jamming signals may exist in low-intensity states, and traditional methods often fail to effectively separate useful features from background noise when jamming signals are weak, leading to missed detections or misjudgments. This presents another challenge. Meanwhile, the PRs among jamming components in the composite jamming signal may dynamically vary over time or across scenarios. However, traditional methods tend to overfit specific power configurations, demonstrating poor adaptability to diverse power combination scenarios and limited robustness. This presents yet another challenge.

### SUMMARY

The present disclosure proposes a novel neural network architecture named ACSNet, based on a deep convolutional neural network (CNN), which incorporates an asymmetric convolutional block (ACB) and a Swish activation function. This special design enhances the network's sensitivity to variations in weak jamming signals, thereby improving the identification accuracy. The robustness and precision of ACSNet highlight its practical feasibility in enhancing the security and reliability of wireless communication systems.

A technical solution of the present disclosure is as follows:

An artificial intelligence-based identification method for a wireless composite jamming signal defines a signal received by a wireless receiver as r(t)=s(t)+j(t)+n(t), where s(t) denotes a useful signal, j(t) denotes a composite jamming signal to be identified, and n(t) denotes an additive white Gaussian noise signal; the composite jamming j(t)=αjᵢ(t)+βjₖ(t) is formed by superimposing two types of single jamming jᵢ(t) and jₖ(t) in a time domain in a wireless communication system, where α and β denote power attenuation factors of jᵢ(t) and jₖ(t), respectively; a composite jamming power ratio (PR) is denoted as

$$PR = \frac{{‖ β ‖}^{2}}{{‖ α ‖}^{2}} ; JNR = 10 {log}_{10} ( \frac{{P}_{J}}{{P}_{N}} )$$

is set to evaluate a jamming intensity relative to noise; P_{J} denotes a jamming signal power; P_{N} denotes a noise power; and the method includes the following steps:

S1: acquiring training set sample data, defining N sample signals r(t) received by the receiver, acquiring r(n) after sampling, and applying Choi-Williams distribution (CWD) to acquire a time-frequency image x⁽ⁿ⁾ for each sample, thereby acquiring a sample dataset

$$D = {\{ ( {x}^{( n )} , {y}^{( n )} ) \}}_{n = 1}^{N} ,$$

where x⁽ⁿ⁾ denotes the time-frequency image of an n-th sample signal, and y⁽ⁿ⁾ denotes a corresponding label;

S2: establishing a composite jamming signal identification model, including following sequentially connected layers: a convolutional layer, a batch normalization (BN) layer, a Swish activation function layer, a first max pooling layer, a first asymmetric convolutional layer, a second max pooling layer, a second asymmetric convolutional layer, a third max pooling layer, a third asymmetric convolutional layer, a fourth max pooling layer, a fourth asymmetric convolutional layer, a fifth max pooling layer, a fifth asymmetric convolutional layer, a sixth max pooling layer, a sixth asymmetric convolutional layer, a global average pooling layer, and a fully connected layer, where the asymmetric convolutional layer structurally includes three parallel branches; each branch includes following sequentially connected layers: a convolutional layer, a BN layer, and a Swish activation function layer; outputs of last three Swish activation function layers are merged as an output of the asymmetric convolutional layer; and convolutional layers of the three branches have different kernel sizes: 1×3, 3×3, and 3×1;

S3: training the established composite jamming signal identification model based on the training set sample data; setting a training objective as to establish an objective function ƒ(x;θ) approximating g(x⁽ⁿ⁾), where g(x⁽ⁿ⁾) denotes a mapping function through which the label y⁽ⁿ⁾ is acquired by inputting x⁽ⁿ⁾ into the model, and ƒ(x;θ) is defined as:

ƒ(x;θ)=w^{T}φ(x)+b
where, φ(x) denotes a feature vector; w denotes a weight vector; and b is a bias term;
evaluating overall performance of the model via a risk function R(θ):

R(θ)=E_{(x,y)~p(x,y)}[L(y,ƒ(x;θ))]
where L(y,ƒ(x;θ)) is a cross-entropy loss function, and p(x, y) denotes a joint distribution of the input x and the label y; and the training objective is designed to minimize R(θ):

θ*=arg min_{θ}R(θ)
performing backpropagation via an adaptive moment estimation (Adam) optimizer, continuously updating a model parameter via the optimizer to minimize the loss function, and acquiring a trained model; and

S4: normalizing the signal after the signal is received by the receiver, acquiring a time-frequency image via CWD, and inputting the acquired time-frequency image into the trained model to determine a category for the signal.

The technical solution of the present disclosure acquires the novel neural network structure ACSNet through the integration of the ACB, aiming to address composite jamming signal identification in wireless communication systems. The present disclosure has the following beneficial effects. The model of the present disclosure enhances the detection capability of neural networks for subtle signal feature variations based on artificial intelligence, thereby improving the identification accuracy for intricate jamming patterns. The present disclosure can effectively address the challenge of jamming signal identification under a low jamming-to-noise ratio (JNR). Additionally, ACSNet demonstrates significant resilience to variations in PRs of composite jamming signals, highlighting its adaptability to real-world environments with imbalanced jamming signal power distributions.

### BRIEF DESCRIPTION OF THE DRAWINGS

FIG. 1 is a structural diagram of an ACB;

FIG. 2 is an overall structural diagram of ACSNet, where “3×3 Conv, 16,1,1” denotes a 3×3 convolutional kernel with 16 filters, a stride of 1, and padding of 1; “2×2 Maxpool, 16,2” denotes a maxpool layer with a kernel size of 2×2, 16 channels, and a stride of 2; “ACB1, 16” denotes the 16-channel ACB shown in FIG. 1; “Adaptiveavgpool” denotes a global averaging pool with an output of (1×1); and “256,Linear” denotes a fully connected layer;

FIG. 3 shows convergence of the model ACSNet during testing, compared with several other conventional neural networks: BCNN, RCNN, and FCNN;

FIG. 4 is a schematic diagram comparing identification performance of several network models under different JNRs; and

FIG. 5 is a schematic diagram comparing identification performance of several network models under different PRs.

### DETAILED DESCRIPTION OF THE EMBODIMENTS

The technical solution of the present disclosure is described in detail below with reference to the drawings and embodiments.

In the present disclosure, a signal received by a wireless receiver is modeled as:

r(t)=s(t)+j(t)+n(t)
where, s(t) denotes a useful signal, j(t) denotes a composite jamming signal to be identified, and the composite jamming signal is generated by methods such as addition, convolution, or multiplication applied to single jamming; and n(t) is characterized as an additive white Gaussian noise signal. The composite jamming is formed by superimposing two common single jamming in a time domain in a wireless communication system, which is expressed as:

j(t)=αjᵢ(t)+βjₖ(t)
α and β denote power attenuation factors of jamming components jᵢ(t) and jₖ(t), respectively. Furthermore, a composite jamming PR is expressed as:

$$PR = \frac{{‖ β ‖}^{2}}{{‖ α ‖}^{2}}$$

Variations in PR help validate the robustness of the proposed method to variations in composite jamming PRs. Additionally, JNR is a critical metric for evaluating a jamming intensity relative to noise, and is expressed as:

$$JNR = 10 {log}_{10} ( \frac{{P}_{J}}{{P}_{N}} )$$

where, P_{J} denotes a jamming signal power, and P_{N} denotes a noise power.

The method specifically includes the following steps.

S1. Training set sample data is acquired. Specifically:

N sample signals r(t) are received by the receiver, and r(n) is acquired after sampling. In the wireless communication system, jamming sources may originate from multiple irregular devices or systems. Amplitudes and frequency components of these jamming signals may vary over time or space, exhibiting non-stationary characteristics. Traditional frequency-based methods (e.g., Fourier transform (TF)) may fail to capture critical time-domain information and instantaneous frequency offsets. CWD is a specific TF analysis method that decomposes signals into sub-signals with distinct frequency components, enabling extraction of time-frequency features. When processing non-stationary wireless jamming signals, CWD surpasses traditional methods such as STFT and WVD. The present disclosure applies CWD to acquire time-frequency images x⁽ⁿ⁾ for individual samples. The calculation process is as follows:

$$W ( t , f ) = {\int }_{- ∞}^{∞} {\int }_{- ∞}^{∞} {A}_{x} ( η , τ ) Φ ( η , τ ) {e}^{j 2 π ( ηt - τf )} d η d τ$$

where,

$${A}_{X} ( η , τ ) = {\int }_{- ∞}^{∞} x ( t + \frac{τ}{2} ) x ( t - \frac{τ}{2} ) {e}^{- j 2 π rt η} d t , W ( t , f )$$

denotes a time-frequency distribution at time t and frequency f, and Φ(η,τ) denotes a weighting or window function designed to mitigate cross-term jamming in the time-frequency representation. This function maintains a balance between frequency and time resolution.

The final dataset is denoted as

$$D = {\{ ( {x}^{( n )} , {y}^{( n )} ) \}}_{n = 1}^{N} ,$$

where x⁽ⁿ⁾ denotes the time-frequency image of an n-th sample signal, and y⁽ⁿ⁾ denotes a corresponding label.

S2. A composite jamming signal identification model is established. Specifically:

Convolutional layers in traditional convolutional neural networks (CNNs) typically employ square convolutional kernels. The present disclosure introduces an ACB into the CNN, replacing these larger kernels with combinations of smaller rectangular kernels such as 1×3 and 3×1. The number of parameters in the convolutional kernel is a significantly reduced. The output of a neuron in an l-th convolutional layer of the CNN is expressed as:

$${z}_{i , j , k} = {\sum }_{u = 1}^{{f}_{{h}^{′}}} {\sum }_{v = 1}^{{f}_{{w}^{′}}} {\sum }_{{k}^{′} = 1}^{{f}_{{n}^{′}}} {x}_{{i}^{′} , {j}^{′} , {k}^{′}} \cdot {w}_{u , v , {k}^{′} , k} + {b}_{k}$$

where, z_{i,j,k} denotes an output of a neuron at position (i, j) in ak-th feature map of the l-th convolutional layer; x_{i′,j′,k′} corresponds to an output at position (i′, j′, k′) in a previous layer's feature map; and w_{u,v,k′,k} denotes a weight of a convolutional kernel, where U and v denote a height and width of a kernel space. Additionally, bₖ is added to the convolutional output of thek-th feature map, enhancing the neuron's capability to properly fit data. Dimension (ƒ_{h′}, ƒ_{w′}, ƒ_{n′}) refers to the height, width, and depth of the previous layer's feature map.

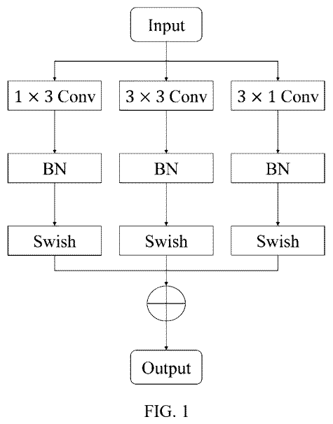

The ACB design adopted in the model of the present disclosure is illustrated in FIG. 1. Specifically, each ACB includes three parallel convolutional layers. Each convolutional layer has different kernel sizes: 1×3, 3×3, and 3×1. Meanwhile, batch normalization (BN) is applied to the output of each convolutional layer in the ACB so as to optimize network performance and stability. After normalization, nonlinear transformation is performed on the output via the activation function, further enhancing the network's capacity to model inherent complex patterns in data.

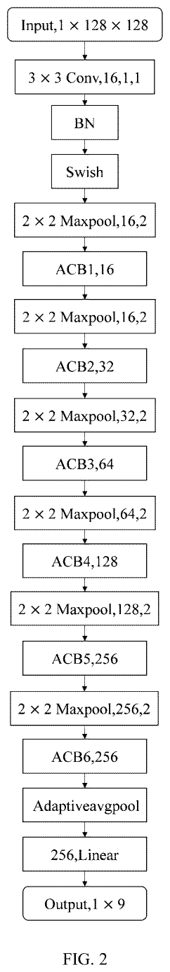

The overall structure of the improved convolutional neural network (CNN) ACSNet is illustrated in FIG. 2. Six ACBs shown in FIG. 1 are integrated. After BN and subsequent linear scaling transformations, the convolutional output z_{i,j, k} is further transformed as:

$${O}_{: , : , j} = \frac{{\sum }_{k = 1}^{C} {M}_{: , : , k} * {F}_{: , : , k}^{( j )} - {μ}_{j}}{{σ}_{j}} {γ}_{i} + {β}_{j}$$

where, O_{:,:,j} denotes the output of aj-th channel after BN and linear scaling. μⱼ and σⱼ denote a mean and standard deviation of the j-th channel, respectively. Additionally, γⱼ and βⱼ are learnable parameters that scale and shift normalized data, enhancing the network's capability to fit specific data features. The total output after BN within an ACB is expressed as:

O_{ACB}=O_{:,:,j}+Ō_{:,:,j}+Ô_{:,:,j}

where, O_{:,:,j}, Ō_{:,:,j}, and Ô_{:,:,j}, denote outputs of the 3×3, 1×3, and 3×1 convolutional layers, respectively. In the design of ACSNet, the Swish function is selected as the activation function to introduce nonlinear features into the network architecture. Its mathematical expression is:

$$f ( x ) = x \cdot sigmoid ( x ) = \frac{x}{1 + {e}^{- x}}$$

Unlike the traditional rectified linear unit (ReLU) function, Swish facilitates more effective gradient propagation throughout the network.

Furthermore, max pooling and global average pooling are combined in the architecture of ACSNet to optimize feature extraction and network efficiency. Specifically, max pooling is placed after the convolutional layers to reduce spatial dimensions and highlight salient local features. Global average pooling is positioned at the terminal part of the network, compressing entire feature maps of each channel into singular values, thereby extracting global features and reducing dimensionality.

S3. The model constructed in S2 is trained based on the training set. x⁽ⁿ⁾ is input to acquire label y⁽ⁿ⁾ through mapping function g(x⁽ⁿ⁾). A training objective is to establish objective function ƒ(x;θ) approximating g(x⁽ⁿ⁾). ƒ(x;θ) is mathematically defined as:

ƒ(x;θ)=w^{T}φ(x)+b
where, φ(x) denotes a feature vector, w denotes a weight vector, and b is a bias term. Risk function R(θ) is adopted to evaluate the overall performance of the model. It is defined as:

R(θ)=E_{(x,y)~p(x,y)}[L(y,ƒ(x;θ))]
where, L(y, ƒ(x;θ)) is the loss function, and p(x, y) denotes a joint distribution of the input x and the label y. In the present disclosure, a cross-entropy loss function is employed as the target loss function:

$$L ( y , f ( x ; θ ) ) = - {\sum }_{v = 1}^{V} {y}_{v} log ( {f ( x ; θ )}_{v} )$$

where, V denotes a number of categories, yᵥ denotes a one-hot encoded label of category v, and ƒ(x;θ)ᵥ denotes a predicted probability of the category V. The primary objective of model training is to minimize R(θ):

θ*=arg min_{θ}R(θ)

The present disclosure adopts an adaptive moment estimation (Adam) optimizer. During backpropagation, a model parameter is continuously updated through the optimizer to minimize the loss function, yielding a trained model.

S4. Composite jamming signal identification is performed. After a signal is received by the receiver, normalization is performed on the signal, and its time-frequency image is acquired via CWD. The trained model is then utilized to accomplish jamming signal identification.

### Embodiment

In this embodiment, the introduced composite jamming is assumed to be a linear superposition in the time domain of five common jamming in wireless communication systems: single-tone jamming, multi-tone jamming, partial-band jamming, linear frequency-sweeping jamming, and impulse jamming.

The specific steps are as follows:

Step 1. A dataset is generated. The signal received by the wireless receiver is normalized and processed via CWD. A Hamming window is applied for windowing to generate a time-frequency spectrum. The size of the input time-frequency image is 1*128*128. The JNR of each jamming in the dataset is set within a dynamic range (−20 dB-10 dB), which better validates the capability of the proposed method model to effectively separate a useful feature from background noise when the jamming signal is weak. Additionally, in the present disclosure, the analysis is extended to broader jamming power ratios PR (−15 dB-20 dB) so as to simulate more realistic jamming conditions commonly encountered in real-world scenarios.

Step 2. The model is constructed according to the structure shown in FIG. 2. Training parameters are configured: the batch size is set to 64, the learning rate is set to 0.01, and the training rounds are set to 400.

Step 3. The model is trained. The predicted output of the network is computed through a forward propagation process. The network model parameter is updated via backpropagation based on a difference between predicted and true values. The target loss function is continuously minimized during training.

Step 4. The trained model is utilized to accomplish a jamming identification task in the wireless communication system.

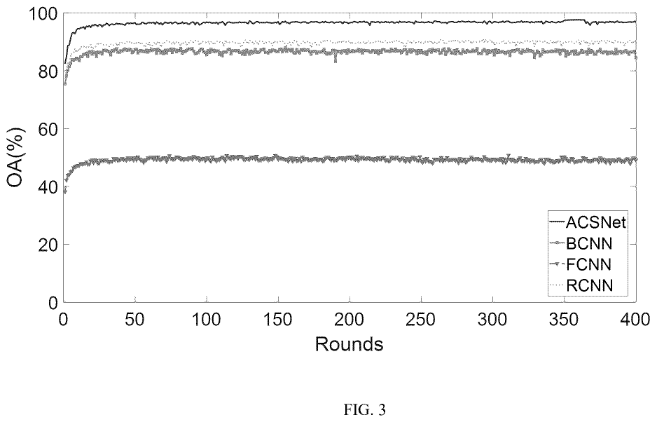

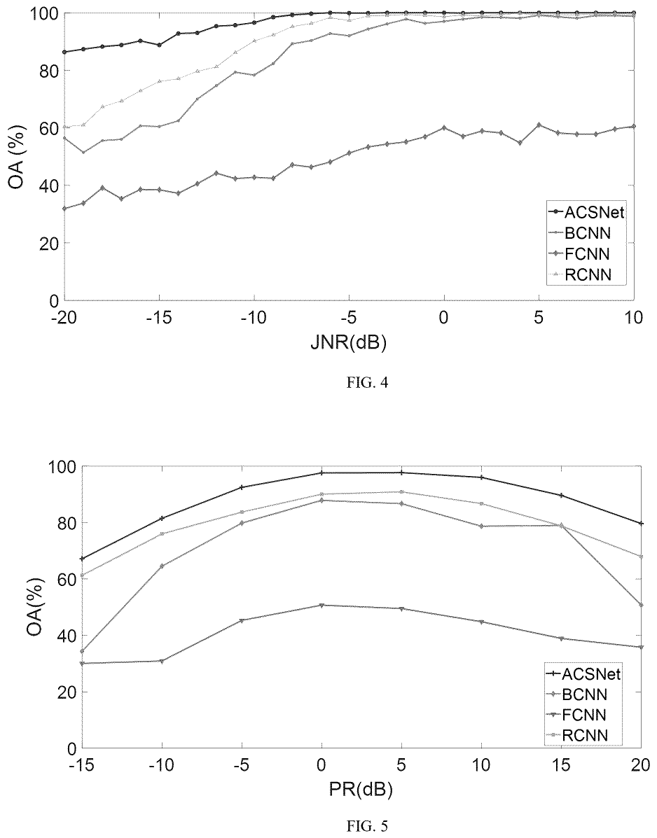

FIGS. 3, 4, and 5 compare identification performance between a conventional CNN and ACSNet. As shown in FIG. 3, the model proposed in the present disclosure exhibits faster convergence speed and achieves high final identification accuracy (97.58%) in jamming identification tasks. FIG. 4 demonstrates that the proposed model maintains high identification accuracy under low JNR conditions, i.e., when the jamming is weak relative to noise. FIG. 5 proves that the proposed model retains high identification accuracy even when PRs of different jamming components within the composite jamming vary, indicating superior generalization capability and robustness to the PRs.

1. An artificial intelligence-based identification method for a wireless composite jamming signal, wherein a signal received by a wireless receiver is defined as r(t)=s(t)+j(t)+n(t), wherein s(t) denotes a useful signal, j(t) denotes a composite jamming signal to be identified, and n(t) denotes an additive white Gaussian noise signal; the composite jamming signal j(t)=αjᵢ(t)+βjₖ(t) is formed by superimposing two types of single jamming signal jᵢ(t) and jₖ (t) in a time domain in a wireless communication system, wherein α and β denote power attenuation factors of jᵢ(t) and jₖ(t), respectively; a composite jamming power ratio (PR) is denoted as
$$PR = \frac{{‖ β ‖}^{2}}{{‖ α ‖}^{2}} ; JNR = 10 {log}_{10} ( \frac{{P}_{J}}{{P}_{N}} )$$
is set to evaluate a jamming intensity relative to noise; P_{J} denotes a jamming signal power; P_{N} denotes a noise power; and
the artificial intelligence-based identification method comprises the following steps:
S1: acquiring training set sample data, defining N sample signals r(t) received by the wireless receiver, acquiring r(n) after sampling, and applying Choi-Williams distribution (CWD) to acquire a time-frequency image x⁽ⁿ⁾ for each sample, thereby acquiring a sample dataset
$$D = {\{ ( {x}^{( n )} , {y}^{( n )} ) \}}_{n = 1}^{N} ,$$
wherein x⁽ⁿ⁾ denotes the time-frequency image of an n-th sample signal, and y⁽ⁿ⁾ denotes a corresponding label;
S2: establishing a composite jamming signal identification model, comprising following sequentially connected layers: a convolutional layer, a batch normalization (BN) layer, a Swish activation function layer, a first max pooling layer, a first asymmetric convolutional layer, a second max pooling layer, a second asymmetric convolutional layer, a third max pooling layer, a third asymmetric convolutional layer, a fourth max pooling layer, a fourth asymmetric convolutional layer, a fifth max pooling layer, a fifth asymmetric convolutional layer, a sixth max pooling layer, a sixth asymmetric convolutional layer, a global average pooling layer, and a fully connected layer, wherein the asymmetric convolutional layer structurally comprises three parallel branches; each branch of the three parallel branches comprises following sequentially connected layers: a convolutional layer, a BN layer, and a Swish activation function layer; outputs of last three Swish activation function layers are merged as an output of the asymmetric convolutional layer; and convolutional layers of the three parallel branches have different kernel sizes: 1×3, 3×3, and 3×1;
S3: training the composite jamming signal identification model based on the training set sample data; setting a training objective as to establish an objective function ƒ(x;θ) approximating g(x⁽ⁿ⁾), wherein g(x⁽ⁿ⁾) denotes a mapping function through which the label y⁽ⁿ⁾ is acquired by inputting x⁽ⁿ⁾ into the composite jamming signal identification model, and ƒ(x;θ) is defined as:
ƒ(x;θ)=w^{T}φ(x)+b
wherein, φ(x) denotes a feature vector; w denotes a weight vector; and b is a bias term;
evaluating overall performance of the composite jamming signal identification model via a risk function R(θ):
R(θ)=E_{(x,y)~(p,y)}[L(y,ƒ(x;θ))]
wherein L(y, ƒ(x;θ)) is a cross-entropy loss function, and p(x, y) denotes a joint distribution of the input x and the label y; and the training objective is designed to minimize R(θ):
θ*=arg min_{θ}R(θ)
performing backpropagation via an adaptive moment estimation (Adam) optimizer, continuously updating a model parameter via the Adam optimizer to minimize the loss function, and acquiring a trained model; and
S4: normalizing the signal after the signal is received by the wireless receiver, acquiring a time-frequency image via CWD, and inputting the time-frequency image into the trained model to determine a category for the signal.
